(19) United States
(12) Patent Application Publication
(10) Pub. No.: US 2022/0315768 A1
(43) Pub. Date: Oct. 6, 2022

(54) LIQUID COMPOSITION FOR FORMING ANTI-GLARE FILM AND PRODUCTION METHOD FOR ANTI-GLARE-FILM-COATED SUBSTRATE

(71) Applicant: NIPPON ELECTRIC GLASS CO., LTD., Otsu-shi, Shiga (JP)

(72) Inventor: Toshiyuki KAJIOKA, Otsu-shi (JP)

(21) Appl. No.: 17/642,253

(22) PCT Filed: Oct. 5, 2020
(86) PCT No.: PCT/JP2020/037773

§ 371 Date: Mar. 11, 2022

(30) Foreign Application Priority Data
Oct. 7, 2019 (JP) 2019-184370

(51) Int. Cl. C09D 5/00; G02B 5/02

(52) U.S. Cl. CPC C09D 5/006; G02B 5/0268

(57) ABSTRACT

Provided are a liquid composition for forming an anti-glare film and a method for producing an anti-glare-film-coated substrate that enable formation of an anti-glare-film-coated substrate preventing reflection on a rough concave-convex surface, such as an anti-glare surface, with a small amount of liquid. A liquid composition for forming an anti-glare film contains a silica precursor and a liquid medium. The liquid medium contains water, a first organic solvent, and a second organic solvent. The first organic solvent is made of an organic solvent having a boiling point of 90° C. or lower and capable of forming an azeotropic mixture having a content mass ratio of 15 or less to water. The azeotropic mixture has an azeotropic point of 90° C. or lower. A content mass ratio of the first organic solvent to water making up part of the liquid medium is equal to or larger than the content mass ratio of the azeotropic mixture to water. The second organic solvent is made of an organic solvent having a boiling point of 90° C. or higher and a content thereof in the liquid medium is not less than 0% and not more than 18% by mass.

### TECHNICAL FIELD

The present invention relates to liquid compositions for forming anti-glare films and anti-glare-film-coated substrates.

### BACKGROUND ART

For example, there is known a technique for forming a principal surface of a transparent article for use in a display device into an anti-glare surface to thus increase the visibility of display. Patent Literature 1 discloses a technique for controlling the surface profile of a light-transmissive plate to prevent reflection thereon.

### CITATION LIST

### Patent Literature

### [PTL 1]

### JP-A-2016-153914

### SUMMARY OF INVENTION

### Technical Problem

In the above literature, the anti-glare surface is formed using the spraying method, but it is necessary to apply a large amount of coating liquid in order to prevent reflection.

An object of the present invention is to provide a liquid composition for forming an anti-glare film and a method for producing an anti-glare-film-coated substrate that enable formation of an anti-glare-film-coated substrate preventing reflection thereon with a small amount of liquid.

### Solution to Problem

A liquid composition for forming an anti-glare film according to the present invention is a liquid composition for forming an anti-glare film, the liquid composition containing a silica precursor and a liquid medium, wherein the liquid medium contains water, a first organic solvent, and a second organic solvent, the first organic solvent is made of an organic solvent having a boiling point of 90° C. or lower and capable of forming an azeotropic mixture having a content mass ratio of 15 or less to water, the azeotropic mixture has an azeotropic point of 90° C. or lower, a content mass ratio of the first organic solvent to the water making up part of the liquid medium is equal to or larger than the content mass ratio of the azeotropic mixture to water, the second organic solvent is made of an organic solvent having a boiling point of 90° C. or higher, and a content of the second organic solvent in the liquid medium is, in terms of % by mass, not less than 0% and not more than 18%.

In the present invention, the first organic solvent is preferably 2-propanol.

In the present invention, the second organic solvent is preferably 1-butanol.

In a method for producing an anti-glare-film-coated substrate according to the present invention, an anti-glare-film-coated substrate is produced by applying the above-described liquid composition for forming an anti-glare film onto a substrate by spray coating.

### Advantageous Effects of Invention

The present invention enables an anti-glare-film-coated substrate preventing reflection thereon to be formed with a small amount of liquid.

### BRIEF DESCRIPTION OF DRAWINGS

FIG. 1 is a schematic cross-sectional view for illustrating a process for producing an anti-glare-film-coated substrate in one embodiment of the present invention.

FIG. 2 is a schematic view showing the anti-glare-film-coated substrate in the one embodiment of the present invention.

### DESCRIPTION OF EMBODIMENTS

Hereinafter, a description will be given of an embodiment of a liquid composition 10 for forming an anti-glare film with reference to the drawings. Note that, in the drawings, a part of the structure may be overdrawn for convenience of illustration. Furthermore, the dimensional ratio between parts may be different from actual one.

A liquid composition 10 for forming an anti-glare film according to the present invention contains a silica precursor and a liquid medium.

Examples of the silica precursor include: silane compounds having a hydrocarbon group attached to a silicon atom and a hydrolyzable group; and hydrolyzed condensates of silane compounds. The silica precursor preferably contains at least one of a silane compound and a hydrolyzed condensate of a silane compound from the viewpoint of preventing the occurrence of cracks in the anti-glare film.

The silane compound has a hydrocarbon group attached to a silicon atom and a hydrolyzable group. The hydrocarbon group may have a group having one or a combination of two or more selected from —O—, —S—, —CO—, and —NR′— (where R′ is a hydrogen atom or a monovalent hydrocarbon group) between carbon atoms.

The hydrocarbon group may be a monovalent hydrocarbon group attached to a single silicon atom or a divalent hydrocarbon group attached to two silicon atoms. Examples of the monovalent hydrocarbon group include an alkyl group, an alkenyl group, and an aryl group. Examples of the divalent hydrocarbon group include an alkylene group, an alkenylene group, and an arylene group.

Examples of the hydrolyzable group include an alkoxy group, an acyloxy group, a ketoxime group, an alkenyloxy group, an amino group, an aminooxy group, an amide group, an isocyanate group, and a halogen atom, and an alkoxy group, an isocyanate group, and a halogen atom (particularly, a chlorine atom) are preferred from the perspective of balance between the stability of the silane compound and ease of hydrolysis. Preferred alkoxy groups are alkoxy groups with one to three carbon atoms and more preferred alkoxy groups are a methoxy group and an ethoxy group.

Examples of the silane compound include alkoxysilanes (such as tetramethoxysilane, tetraethoxysilane, and tetraisopropoxysilane), alkoxysilanes having an alkyl group (such as methyltrimethoxysilane and ethyltriethoxysilane), alkoxysilanes with a vinyl group (such as vinyltrimethoxysilane and vinyltriethoxysilane), alkoxysilanes with an epoxy group (such as 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane), and alkoxysilanes with an acryloyloxy group (such as 3-acryloyloxypropyltrimethoxysilane). Of these silane compounds, one or both of an alkoxysilane and a hydrolyzed condensate of an alkoxysilane are preferably used and a hydrolyzed condensate of an alkoxysilane is more preferably used.

The liquid medium contained in the liquid composition 10 for forming an anti-glare film is a solvent for dissolving the silica precursor, contains water and a first organic solvent, and contains a second organic solvent in an amount of not less than 0% and not more than 18% by mass.

Water is a component that promotes hydrolysis and condensation of the silica precursor to form an anti-glare film. The content of water in the liquid medium is, in terms of % by mass, preferably not less than 5%, more preferably not less than 6%, preferably not more than 15%, more preferably not more than 10%, and still more preferably not more than 8%.

The first organic solvent has a boiling point of 90° C. or lower. In this case, in forming an anti-glare film, the first organic solvent is likely to volatilize and, therefore, a change in gloss of the formed anti-glare-film-coated substrate can be effectively prevented.

In addition, the first organic solvent can form an azeotropic mixture having a content mass ratio of 15 or less to water. Thus, when the liquid medium contains the first organic solvent, water can easily volatilize from a coating film in forming the coating film by applying the liquid medium onto a substrate by spray coating, so that the gloss of the formed anti-glare-film-coated substrate can be effectively reduced. The content mass ratio of the formed azeotropic mixture to water is preferably 12 or less, more preferably 10 or less, and still more preferably 8 or less.

Examples of the first organic solvent include 2-propanol, ethyl methyl ketone, and ethyl acetate. Of these first organic solvents, 2-propanol is preferred because it is an alcohol and is therefore safer and easier to handle than the other liquid media.

Furthermore, the azeotropic mixture has an azeotropic point of 90° C. or lower . In this case, water can easily volatilize from a coating film in forming the coating film by applying the liquid medium onto a substrate by spray coating, so that the gloss of the formed anti-glare-film-coated substrate can be effectively reduced.

Moreover, the content mass ratio of the first organic solvent to water making up part of the liquid medium is equal to or larger than the content mass ratio of the azeotropic mixture to water. In this case, water can preferentially volatilize from a coating film in forming the coating film by applying the liquid medium onto a substrate by spray coating, so that the gloss of the formed anti-glare-film-coated substrate can be effectively reduced.

The azeotropic point of an azeotropic mixture of water and 2-propanol is 80.1° C. and the content mass ratio of 2-propanol to water in the azeotropic mixture is 7.1. The azeotropic point of an azeotropic mixture of water and ethyl methyl ketone 73.6° C. and the content mass ratio of ethyl methyl ketone to water in the azeotropic mixture is 7.1. The azeotropic point of an azeotropic mixture of water and ethyl acetate is 70.5° C. and the content mass ratio of ethyl acetate to water in the azeotropic mixture is 11.7.

The second organic solvent is made of an organic solvent having a boiling point of 90° C. or higher and the content thereof in the liquid medium is, in terms of % by mass, not less than 0% and not more than 18%. The second organic solvent can control hydrolysis and condensation of the silica precursor to increase the safety over time of the liquid composition 10 for forming an anti-glare film. If the content of the second organic solvent in the liquid medium is too high, the second organic solvent becomes less likely to volatilize from a coating film in forming the coating film by applying the liquid medium onto a substrate by spray coating, so that the gloss of the formed anti-glare-film-coated substrate becomes high. Examples of the second organic solvent include 1-propanol, 1-butanol, 2-butanol, isobutanol, 1,4-dioxane, methyl isobutyl ketone, methyl cellosolve, ethyl cellosolve, N,N-dimethylformamide, N,N-dimethylacetamide, diacetone alcohol, dimethyl sulfoxide, and N-methylpyrrolidone.

The liquid medium may contain, in addition to the above components, methanol, ethanol, ketones, ethers, esters, and so on. An example of ketones is acetone. An example of ethers is tetrahydrofuran. An example of esters is methyl acetate. These liquid media may be used singly or in combination of two or more of them.

The liquid composition 10 for forming an anti-glare film may contain an acid catalyst or a base catalyst that further promote the hydrolysis and condensation of the silica precursor. The acid catalyst is a component that promotes the hydrolysis and condensation of the silica precursor to form an anti-glare film in a short time. The acid catalyst and the base catalyst may be added, in preparing a solution of the silica precursor prior to the preparation of the liquid composition 10 for forming an anti-glare film, for the purpose of hydrolysis and condensation of a raw material (such as alkoxysilane) or may be additionally added after the preparation of essential components. Examples of the acid catalyst include inorganic acids (such as nitric acid, sulfuric acid, and hydrochloric acid) and organic acids (such as formic acid, oxalic acid, acetic acid, monochloroacetic acid, dichloroacetic acid, and trichloroacetic acid). Examples of the base catalyst include ammonia and potassium hydroxide.

Next, a description will be given of a method for producing an anti-glare-film-coated substrate 20.

The method for producing an anti-glare-film-coated substrate 20 includes a deposition step of depositing an anti-glare film 22 on a substrate 21. This deposition step includes a formation step of applying a liquid composition 10 for forming an anti-glare film onto the substrate 21 and then drying the liquid composition 10 to form an anti-glare film 22.

Examples of the method for applying the liquid composition 10 for forming an anti-glare film onto the substrate 21 in the formation step include known wet coating methods (including spray coating, spin coating, dip coating, die coating, curtain coating, screen coating, ink-jet coating, flow coating, gravure coating, bar coating, flexographic coating, slit coating, and roll coating). Spray coating is preferred as the application method from the perspective of ease of formation of asperities.

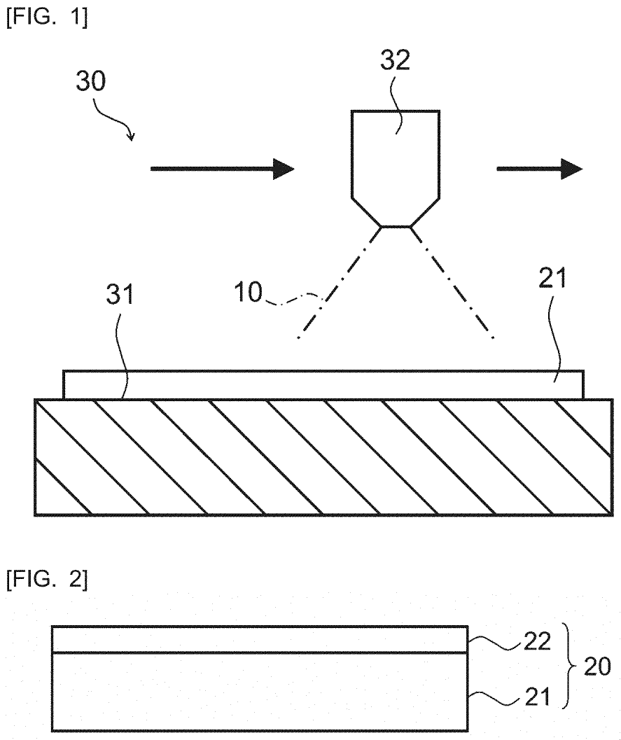

In spray coating, for example, a spray coater 30 as shown in FIG. 1 is used. In the spray coater 30, the liquid composition 10 for forming an anti-glare film is sprayed, through a nozzle 32 disposed above a substrate 21 placed on a base 31, to the substrate 21. Thus, a coating film is formed on the substrate 21. Then, the coating film is dried to form an anti-glare film 22, resulting in completion of an anti-glare-film-coated substrate 20.

The nozzle 32 to be used is a two-fluid nozzle, a single-fluid nozzle or so on. The particle diameter of liquid drops of the liquid composition 10 for forming an anti-glare film to be discharged through the nozzle 32 is normally 0.1 to 100 μm and preferably 1 to 50 μm. When the particle diameter of the liquid drops is not less than 0.1 μm, asperities enabling full expression of an anti-glare effect can be formed in a short time. When the particle diameter of the liquid drops is not more than 100 μm, appropriate asperities enabling full expression of an anti-glare effect can be easily formed. The particle diameter of the liquid drops of the liquid composition 10 for forming an anti-glare film can be appropriately adjusted by the type of the nozzle 32, the spraying pressure, the amount of liquid, and so on. For example, in the two-fluid nozzle, the liquid drops become smaller with increasing spraying pressure, whereas the liquid drops become larger with increasing amount of liquid. The particle diameter of the liquid drops is a Sauter mean particle diameter measured with a laser diffraction particle size distribution measuring device.

The amount of use of the liquid composition 10 for forming an anti-glare film per unit area of the substrate is preferably not less than 30 L/m² and not more than 100 L/m². If this amount of use is too large, the haze of the formed anti-glare-film-coated substrate 20 becomes large. Therefore, when the anti-glare-film-coated substrate 20 is used as a cover glass for a display, the resolution of the display is likely to decrease. On the other hand, if the above amount of use is too small, the gloss of the formed anti-glare-film-coated substrate 20 becomes large. Therefore, when the anti-glare-film-coated substrate 20 is used as a cover glass for a display, it is difficult to prevent the reflection of the display.

The surface temperature of an application target (for example, the substrate 21) during application of the liquid composition 10 for forming an anti-glare film is, for example, 20 to 75° C., preferably 35° C. or higher, and more preferably 60° C. or higher. A preferred method for heating the application target is, for example, to use a hot-water circulating heating device. The humidity during application of the liquid composition 10 for forming an anti-glare film to the application target is, for example, 20 to 80% and preferably 50% or higher.

The drying of the coating film on the substrate 21 may be drying by heating or drying at ordinary temperatures. The drying time for which the coating film on the substrate 21 is dried is, for example, preferably 30 seconds or more. The drying of the coating film on the substrate 21 is preferably drying under a clean laminar flow at a constant temperature and a constant humidity. The temperature, humidity, and flow rate of the laminar flow during drying is, for example, preferably 15 to 30° C., 50 to 70%, and 0.01 to 1 m/sec, respectively.

The anti-glare-film-coated substrate 20 formed in the above manner includes, as shown in FIG. 2, a substrate 21 and an anti-glare film 22 deposited on one of both principal surfaces of the substrate 21.

Examples of the material for the substrate 21 include glass and resin. Examples of the glass that can be used include known glasses, such as alkali-free glass, aluminosilicate glass, and soda-lime glass. Alternatively, strengthened glasses, such as chemically strengthened glass, or crystallized glasses, such as LAS-based crystallized glass, can be used. Examples of the resin include acrylic resins, such as methyl polymethacrylate, polycarbonate resins, and epoxy resins.

The substrate 21 is preferably a glass substrate and more preferably a strengthened glass substrate. Of strengthened glasses, chemically strengthened glass is preferably used. Aluminosilicate glass is more preferably used from the perspective of glass composition. The aluminosilicate glass preferably contains, in terms of % by mass, 50 to 80% SiO₂, 5 to 25% Al₂O₃, 0 to 15% B₂O₃, 1 to 20% Na₂O, and 0 to 10% K₂O.

For example, a plate-like substrate having a thickness in a range of 0.1 to 5 mm is used as the substrate 21.

The anti-glare film 22 forms an anti-glare surface having a concave-convex structure capable of scattering light. The anti-glare film 22 is made of an oxide containing SiO₂. The thickness of the anti-glare film 22 is, for example, preferably in a range of 40 to 500 nm.

The anti-glare-film-coated substrate 20 can be suitably used, for example, as a cover member for a display device. The display device includes, for example, a light source and a liquid crystal display. The display device may have a touch panel function. The anti-glare-film-coated substrate 20 having light permeability preferably has, for example, an average transmittance of 80% or more to light with wavelengths of not less than 400 nm and not more than 1100 nm.

### EXPERIMENTAL EXAMPLES

Next, a description will be given of experimental examples.

In the experimental examples, samples of anti-glare-film-coated substrates were produced using liquid compositions for forming an anti-glare film.

Each of the liquid compositions for forming an anti-glare film in Experimental Examples 1 to 5 was prepared by mixing a silica precursor and a liquid medium having a composition shown in Table 1 so that the solid concentration after drying of a solvent reached a value as shown in Table 1. Tetraethoxysilane was used as the silica precursor, 2-propanol was used as the first organic solvent, and 1-butanol was used as the second organic solvent.

TABLE 1

| | | Exper. | Exper. | Exper. | Exper. | Exper. |
|---|---|---|---|---|---|---|
| | | Ex. 1 | Ex. 2 | Ex. 3 | Ex. 4 | Ex. 5 |
| Composition | ethanol | — | 79.3 | 61.9 | 79.2 | — |
| of Liquid | methanol | — | 0.8 | 0.9 | 12.5 | — |
| Medium, | 2-propanol | 93.4 | 12.7 | 9.7 | 1.0 | 75.0 |
| wt % | 1-butanol | — | — | 20.7 | — | 19.0 |
| | water | 6.6 | 7.2 | 6.8 | 7.2 | 5.9 |

| | | | | | |
|---|---|---|---|---|---|
| 2-Propanol/Water | 14.2 | 1.8 | 1.4 | 0.1 | 12.7 |
| Mass Ratio | | | | | |
| Solid Concentration, | 2.8 | 3.1 | 2.9 | 3.1 | 2.6 |
| wt % | | | | | |

As a substrate for use in obtaining each of samples of anti-glare-film-coated substrates, a glass substrate (a chemically strengthened glass substrate T2X-1, 1.3 mm thick, manufactured by Nippon Electric Glass Co., Ltd.) was used. Each of the samples of the anti-glare-film-coated substrates in Experimental Examples 6 to 18 was obtained by spray-coating a liquid composition for forming an anti-glare film onto one principal surface of the above substrate and drying the liquid composition to form an anti-glare film on the substrate. A two-fluid nozzle was used as the nozzle for a spray coater, wherein the flow rate of the liquid composition for forming an anti-glare film was 0.4 L/hr, and the flow rate of air was 230 L/min. The respective amounts of use of the liquid compositions for forming an anti-glare film were as shown in Tables 2 and 3.

TABLE 2

| | Exper. | Exper. | Exper. | Exper. | Exper. | Exper. |
|---|---|---|---|---|---|---|
| | Ex. 6 | Ex. 7 | Ex. 8 | Ex. 9 | Ex. 10 | Ex. 11 |
| Liquid Composition for | Exper. | Exper. | Exper. | Exper. | Exper. | Exper. |
| Forming Anti-Glare Film | Ex. 1 | Ex. 1 | Ex. 1 | Ex. 2 | Ex. 2 | Ex. 2 |
| Amount of Use of Liquid | 89 | 67 | 53 | 89 | 67 | 53 |
| Composition, L/m² | | | | | | |
| Gloss Value | 45 | 47 | 63 | 65 | 87 | 103 |
| Liquid Efficiency | 1.24 | 1.61 | 1.74 | 1.01 | 1.01 | 0.98 |

TABLE 3

| | Exper. | Exper. | Exper. | Exper. | Exper. | Exper. | Exper. |
|---|---|---|---|---|---|---|---|
| | Ex. 12 | Ex. 13 | Ex. 14 | Ex. 15 | Ex. 16 | Ex. 17 | Ex. 18 |
| Liquid Composition for | Exper. | Exper. | Exper. | Exper. | Exper. | Exper. | Exper. |
| Forming Anti-Glare Film | Ex. 3 | Ex. 3 | Ex. 3 | Ex. 4 | Ex. 5 | Ex. 5 | Ex. 5 |
| Amount of Use of Liquid | 89 | 67 | 53 | 67 | 89 | 67 | 53 |
| Composition, L/m² | | | | | | | |
| Gloss Value | 65 | 79 | 95 | 103 | 75 | 80 | 100 |
| Liquid Efficiency | 1.01 | 1.13 | 1.13 | 0.78 | 0.90 | 1.12 | 1.04 |

For the sample in each of the experimental examples, the gloss value was measured and the liquid efficiency was determined from the gloss value.

### Measurement of Gloss Value

The gloss value of the sample in each of the experimental examples at an incidence angle of 60° on its concave-convex surface was measured in conformity to JIS 28741 (1997) . The gloss value is a value measured inclusive of reflected light from the reverse surface (the surface opposite to the concave-convex surface) . The results are shown in the “Gloss Value” rows in Tables 2 and 3.

### Liquid Efficiency

The liquid efficiency was determined based on the formula (1) below from the gloss value and the amount of use of the liquid composition for forming an anti-glare film per unit area of the substrate. The results are shown in the “Amount of Use of Liquid Composition” rows in Tables 2 and 3.

Liquid efficiency=((155-(gloss value))/(amount of use of liquid composition for forming anti-glare film per unit area of substrate) ... (1)

As the value of the liquid efficiency is larger, the gloss value can be reduced with a smaller amount of use of the liquid composition for forming an anti-glare film and, therefore, the reflection of the anti-glare-film-coated substrate can be more effectively prevented. The constant “155” in the formula (1) indicates a gloss value measured in glass with no anti-glare film formed thereon.

The gloss values of the samples in Experimental Examples 6 to 9 and 12 are 65 or less and smaller than the gloss values of the samples in Experimental Examples 10, 11, and 13 to 18. It can be seen from these results that the samples in Experimental Examples 6 to 9 and 12 can more effectively prevent the reflection of the anti-glare-film-coated substrates than the samples in Experimental Examples 10, 11 and 13 to 18.

The liquid efficiencies of the samples in Experimental Examples 6 to 8 are 1.24 or more and higher than the liquid efficiencies of the samples in Experimental Examples 9 to 18. It can be seen from these results that, in the samples in Experimental Examples 6 to 8, the amount of use of the liquid composition for forming an anti-glare film can be more effectively reduced than in the samples in Experimental Examples 9 to 18.

### REFERENCE SIGNS LIST

10 ... liquid composition for forming an anti-glare film, 20 ... anti-glare-film-coated substrate, 21 ... substrate, 22 ... anti-glare film, 30 ... spray coater, 31 ... base, 32 ... nozzle

1. A liquid composition for forming an anti-glare film, the liquid composition containing a silica precursor and a liquid medium, wherein
the liquid medium contains water, a first organic solvent, and a second organic solvent,
the first organic solvent is made of an organic solvent having a boiling point of 90° C. or lower and capable of forming an azeotropic mixture having a content mass ratio of 15 or less to water,
the azeotropic mixture has an azeotropic point of 90° C. or lower,
a content mass ratio of the first organic solvent to the water making up part of the liquid medium is equal to or larger than the content mass ratio of the azeotropic mixture to water,
the second organic solvent is made of an organic solvent having a boiling point of 90° C. or higher, and
a content of the second organic solvent in the liquid medium is, in terms of % by mass, not less than 0% and not more than 18%.

2. The liquid composition for forming an anti-glare film according to claim 1, wherein the first organic solvent is 2-propanol.

3. The liquid composition for forming an anti-glare film according to claim 1, wherein the second organic solvent is 1-butanol.

4. A method for producing an anti-glare-film-coated substrate, the method comprising the step of applying the liquid composition for forming an anti-glare film according to claim 1 onto a substrate by spray coating to produce an anti-glare-film-coated substrate.
